(19) United States
(12) Patent Application Publication
(10) Pub. No.: US 2011/0133728 A1
(43) Pub. Date: Jun. 9, 2011

(54) ANGLE SENSOR

(75) Inventor: Ichiro TOKUNAGA, Miyagi-Ken (JP)

(73) Assignee: ALPS ELECTRIC CO., LTD., Tokyo (JP)

(21) Appl. No.: 13/027,186

(22) Filed: Feb. 14, 2011

Related U.S. Application Data
(63) Continuation of application No. PCT/JP2009/065192, filed on Aug. 31, 2009.

(30) Foreign Application Priority Data
Sep. 3, 2008 (JP) 2008-225872
May 25, 2009 (JP) 2009-125079

(51) Int. Cl. G01B 7/30

(52) U.S. Cl. 324/207.21

(57) ABSTRACT

An angle sensor includes: a magnet mounted in a rotatable rotation body so as to be rotatable with the rotation body; a circular yoke extending in a circular shape so as to surround an outer circumferential surface of the magnet around a rotation shaft of the magnet and having a notched portion in a part thereof in an extension direction of the circular yoke; and a magneto-resistive effect element disposed in the notched portion and detecting a direction of a magnetic field generated in the notched portion. A rotation angle of the magnet matches a direction of a magnetic field applied to the GMR element.

### CLAIM OF PRIORITY

This application is a Continuation of International Application No. PCT/JP2009/065192 filed on Aug. 31, 2009, which claims benefit of Japanese Patent Application No. 2008-225872 filed on Sep. 3, 2008 and No. 2009-125079 filed on May 25, 2009. The entire contents of each application noted above are hereby incorporated by reference.

### BACKGROUND OF THE INVENTION

1. Field of the Invention

The present invention relates to an angle sensor, and more particularly, to an angle sensor suitable for high angle detection precision.

2. Description of the Related Art

In the past, there was suggested a hall sensor which includes a hall element disposed opposite at a neutral detection position with respect to a magnet mounted on a rotation shaft and detects a rotation angle of the magnet based on a signal output from the hall element (for example, see Japanese Unexamined Patent Application Publication No. 2003-151390). In the angle sensor, the rectangular parallelepiped magnet is disposed in the middle of the rotation shaft and the hall element is disposed near the outer circumferential surface of the rotation shaft. The angle sensor is configured to calculate the rotation angle of the magnet depending on the strength of a magnetic field applied from the magnet to the hall element.

On the other hand, there was suggested a magnetic sensor using a giant magneto-resistive effect element (GMR element) detecting a direction of a magnetic field from a magnet and varying an output signal (for example, see Japanese Unexamined Patent Application Publication No. 2006-276983). The magnetic sensor using the GMR element varies the output signal based on a variation in an electric resistant value of the GMR element corresponding to the direction of the magnetic field from the magnet.

It can be considered that the GMR element (giant magneto-resistive effect element) is provided instead of the hall element of the angle sensor disclosed in Japanese Unexamined Patent Application Publication No. 2003-151390, to configure the angle sensor using the GMR element. However, when the GMR element detecting a direction of a magnetic field on the outer circumferential surface of a rotation body is provided, as in the angle sensor disclosed in Japanese Unexamined Patent Application Publication No. 2003-151390, a problem may arise in that the rotation angle of the magnet and the direction of the magnetic field applied to the GMR element do not correspond to each other and the rotation angle of the magnet is not appropriately detected.

### SUMMARY OF THE INVENTION

In light of the foregoing, it is desirable to provide an angle sensor capable of improving angle detection precision using a gigantic magneto-resistive effect element.

According to an aspect of the invention, there is provided an angle sensor including: a magnet mounted in a rotatable rotation body so as to be rotatable with the rotation body; a circular yoke extending in a circular shape so as to surround an outer circumferential surface of the magnet around a rotation shaft of the magnet and having a notched portion in a part thereof in an extension direction of the circular yoke; and a magneto-resistive effect element disposed in the notched portion. The magneto-resistive effect element detects a direction of a magnetic field matching a rotation angle of the magnet in the notched portion.

With such a configuration, a magnetic path is formed by the circular yoke in which the notched portion is formed. Therefore, for example, when the magnetic pole of the magnet is located in a straight line of the magneto-resistive effect element, a part of the magnetic flux is drawn toward the circular yoke from the notched portion and thus the magnetic flux applied to the magneto-resistive effect element decreases. When the magnet is rotated by 90 degrees from the position, the magnetic flux is drawn by the circular yoke and thus the magnetic flux applied to the magneto-resistive effect element increases. Therefore, when the notched portion allows the strength of the magnetic field applied to the magneto-resistive effect element to be uniform irrespective of the rotation angle of the magnet, the rotation angle of the magnet can be made to match the direction of the magnetic field applied to the magneto-resistive effect element, thereby improving the angle detection precision.

In the angle sensor according to the aspect of the invention, the outer circumferential surface of the magnet around the rotation shaft of the magnet may be circular.

With such a configuration, for example, the rotation angle of the magnet can be made to match the direction of the magnetic field applied to the magneto-resistive effect element even for a columnar magnet or a ring magnet.

In the angle sensor according to the aspect of the invention, the notched portion may have a gap width so that an amplitude ratio of an orthogonal component of a magnetic field applied to the magneto-resistive effect element is 1.

With such a configuration, since the amplitude ratio of the orthogonal component of the magnetic field applied to the magneto-resistive effect element is 1, the strength of the magnetic field applied to the magneto-resistive effect element can be made uniform, irrespective of the rotation angle of the magnet.

In the angle sensor according to the aspect of the invention, the circular yoke may be formed in a circular ring shape. The gap width of the notched portion may be in the range from ⅛ to 1/12 of a center diameter of the circular yoke.

In the angle sensor according to the aspect of the invention, the gap width of the notched portion may be 1/10 of the center diameter of the circular yoke.

With such a configuration, by determining the center diameter of the circular yoke, it is possible to determine the gap width of the notched portion allowing the strength of the magnetic field applied to the magneto-resistive effect element to be uniform irrespective of the rotation angle of the magnet. The center diameter of the circular yoke is a diameter which is half of the sum of the inner diameter and the outer diameter of the circular yoke.

According to another aspect of the invention, there is provided an angle sensor including: a magnet mounted in a rotatable rotation body so as to be rotatable with the rotation body; a circular yoke extending in a circular shape so as to surround an outer circumferential surface of the magnet around a rotation shaft of the magnet and having a plurality of notched portions in parts thereof in an extension direction of the circular yoke; and a magneto-resistive effect element disposed in one of the plurality of notched portions and detecting a direction of a magnetic field generated in the notched portion in which the magneto-resistive effect element is disposed.

With such a configuration, a magnetic path is formed by the circular yoke in which the plurality of notched portions is formed. Therefore, for example, when the magnetic pole of the magnet is located in a straight line of the magneto-resistive effect element, a part of the magnetic flux is drawn toward the circular yoke from the notched portion and thus the magnetic flux applied to the magneto-resistive effect element decreases. When the magnet is rotated by 90 degrees from the position, the magnetic flux is drawn by the circular yoke and thus the magnetic flux applied to the magneto-resistive effect element increases. Therefore, when the plurality of notched portions allow the strength of the magnetic field applied to the magneto-resistive effect element to be uniform irrespective of the rotation angle of the magnet, the rotation angle of the magnet can be made to match the direction of the magnetic field applied to the magneto-resistive effect element, thereby improving the angle detection precision. Moreover, when the magnetic resistance of the magnetic path along which the magnetic flux flows in one direction is nearly the same as the magnetic resistance of the magnetic path along which the magnetic flux flows in the reverse direction to the one direction in the circular yoke, a bias of the magnetic flux density in the circular yoke can be reduced. Accordingly, by suppressing the reduction in the magnetic flux applied to the magneto-resistive effect element, the detection sensitivity can be improved and the leakage of the magnetic flux can be prevented.

In the angle sensor according to the aspect of the invention, the outer circumferential surface of the magnet around the rotation shaft of the magnet may be circular.

With such a configuration, for example, the rotation angle of the magnet can be made to match the direction of the magnetic field applied to the magneto-resistive effect element even for a columnar magnet or a ring magnet.

In the angle sensor according to the aspect of the invention, the plurality of notched portions may be formed in the circular yoke so that a magnetic resistance of a magnetic path along which a magnetic flux flows through the circular yoke in one direction is substantially the same as a magnetic resistance of a magnetic path along which a magnetic flux flows through the circular yoke in a reverse direction to the one direction.

With such a configuration, by reducing the bias of the magnetic flux density in the circular yoke and suppressing reduction in the magnetic flux applied to the magneto-resistive effect element, the detection sensitivity can be improved and the leakage of the magnetic flux can be prevented.

In the angle sensor according to the aspect of the invention, the plurality of notched portions may be two. The two notched portions may be formed at positions of the circular yoke which substantially face each other with a rotation center of the magnet therebetween.

With such a configuration, the magnetic resistance of the magnetic path along which the magnetic flux flows in one direction can be made to be nearly the same as the magnetic resistance of the magnetic path along which the magnetic flux flows in the reverse direction to the one direction in the circular yoke.

In the angle sensor according to the aspect of the invention, gap widths of the two notched portions may be formed so that an amplitude ratio of an orthogonal component of a magnetic field applied to the magneto-resistive effect element is 1.

With such a configuration, since the amplitude ratio of the orthogonal component of the magnetic field applied to the magneto-resistive effect element is 1, the strength of the magnetic field applied to the magneto-resistive effect element can be made uniform, irrespective of the rotation angle of the magnet.

In the angle sensor according to the aspect of the invention, the circular yoke may be formed in a circular ring shape. The gap widths of the two notched portions may be in the range from ⅛ to 1/12 of a center diameter of the circular yoke.

With such a configuration, by determining the center diameter of the circular yoke, it is possible to determine the gap widths of the two notched portions allowing the strength of the magnetic field applied to the magneto-resistive effect element to be uniform irrespective of the rotation angle of the magnet. The center diameter of the circular yoke is a diameter which is half of the sum of the inner diameter and the outer diameter of the circular yoke.

According to the aspects of the invention, the angle detection precision can be improved using the magneto-resistive effect element.

### BRIEF DESCRIPTION OF THE DRAWINGS

FIG. 1 is a schematic diagram illustrating an angle sensor according to an embodiment of the invention.

FIG. 2 is a diagram illustrating a magnetic field generated from the angle sensor according to a comparative example.

FIGS. 3A to 3C are diagrams illustrating the state transition of the angle sensor according to a comparative example.

FIG. 4 is a diagram illustrating a linear characteristic of the angle sensor according to a comparative example.

FIG. 5A is a diagram illustrating the state of a magnetic flux applied to a GMR element when a magnet is located at an initial position. FIG. 5B is a diagram illustrating the state of a magnetic flux applied to the GMR element when the magnet is located at the position at which the magnet is rotated by 90 degrees from the initial position.

FIGS. 6A to 6C are diagrams illustrating the state transition of the angle sensor according to this embodiment of the invention.

FIG. 7 is a diagram illustrating a linear characteristic of the angle sensor according to the embodiment of the invention.

FIG. 8 is a diagram illustrating the design of a circular yoke of the angle sensor according to the embodiment of the invention.

FIG. 9 is a diagram illustrating the relationship between the width size of a gap width of the circular yoke shown in FIG. 8 and an amplitude ratio of the orthogonal component of the magnetic field applied to the GMR element in the angle sensor according to the embodiment of the invention.

FIG. 10 is a schematic view illustrating an angle sensor according to another embodiment of the invention.

FIG. 11 is a diagram illustrating the design of a circular yoke of the angle sensor according to another embodiment of the invention.

FIG. 12 is a diagram illustrating the flow of a magnetic flux of an angle sensor according to a comparative example.

FIG. 13 is a diagram illustrating the flow of a magnetic flux of an angle sensor according to another embodiment of the invention.

FIGS. 14A and 14B are diagrams illustrating the relationship between a rotation angle of the angle sensor and a variation width of a magnetic flux density according to another embodiment of the invention.

### DESCRIPTION OF THE PREFERRED EMBODIMENTS

Hereinafter, embodiments of the invention will be described in detail with reference to the accompanying drawings. An angle sensor according to the embodiments of the invention is an angle sensor used to calculate high angle detection precision of a crank angle or the like in an engine mounted on an automobile or the like. Hereinafter, a case will be described in which the angle sensor according to the embodiments of the invention is applied to a crank angle sensor, as necessary.

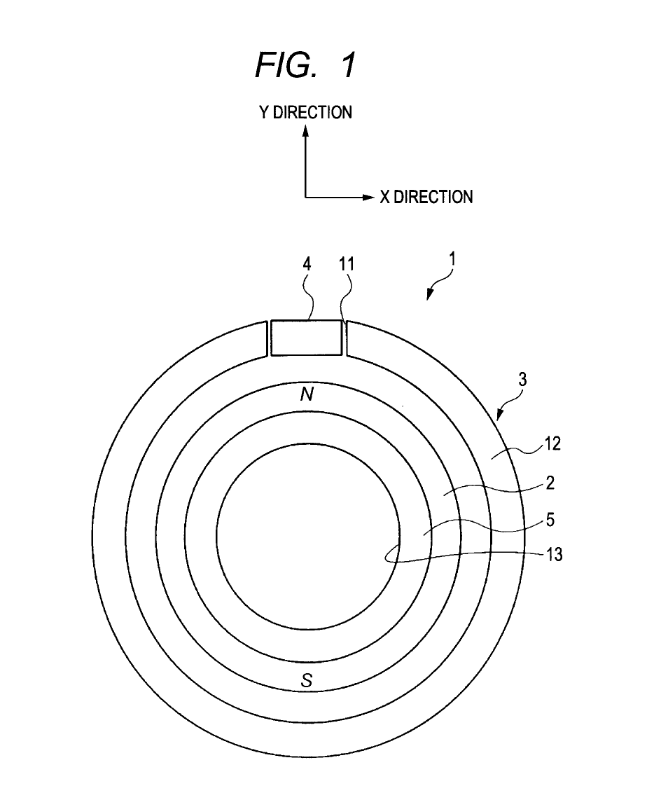

FIG. 1 is a schematic diagram illustrating the angle sensor according to an embodiment of the invention. As shown in FIG. 1, an angle sensor 1 according to this embodiment includes a magnet 2 with a circular ring shape, a circular yoke 3 surrounding the outer circumferential surface of the magnet 2 and having a notched portion 11 in a part thereof, and a GMR element 4 serving as a magneto-resistive effect element disposed in the noticed portion 11 of the circular yoke 3. An annular mounting member 5 is disposed on the inner circumferential surface of the magnet 2 and a mounting hole 13 through which a crank shaft (not shown) or the like can be inserted is formed in the middle of the mounting member 5.

The magnet 2 formed in a circular ring shape is affixed to the outer circumferential surface of the mounting member 5 so as not to be relatively rotatable. The magnet 2, in which the N pole and the S pole are magnetized at two positions facing each other in a radial direction, generates an arc magnetic field from the N pole to the S pole via the circular yoke 3 in the periphery thereof. The width of the magnet 2 is set to correspond to the vertical thickness of the GMR element 4. However, the width of the magnet 2 may be set to be larger, as long as the width is not smaller.

The circular yoke 3, which has the notched portion 11 in an annular portion 12 and is formed in a C shape in a front view, is disposed with a uniform void gap formed in a radial direction between the circular yoke 3 and the outer circumferential surface of the magnet 2. The annular portion 12 and the notched portion 11 of the circular yoke 3 form a magnetic path of the magnetic field generated from the magnet 2 and thus uniformly maintain the strength of the magnetic field applied to the GMR element 4, irrespective of the rotation angle of the magnet 2. The detailed magnetic path formed by the circular yoke 3 will be described below.

The GMR element 4, which is disposed in the notched portion 11 of the circular yoke 3, detects the direction of the magnetic field generated from the magnet 2. The GMR element 4 has a basic configuration in which an alternating bias layer (antiferromagnetic layer), a fixing layer (pinned magnetic layer), a nonmagnetic layer, and a free layer (free magnetic layer) are laminated on a wafer (not shown) and is configured as a magneto-resistive effect element which is a kind of GMR (Giant Magnet Resistance) element using the giant magneto-resistive effect.

The angle sensor 1 according to this embodiment has such a configuration, and an outside magnetic field generated by the magnet 2, that is, the magnetic field generated from the magnet 2, is applied to the GMR element 4. A variation in the electric resistance value of the GMR element 4 is caused due to a direction of the corresponding magnetic field, and a rotation angle of the magnet 2 is detected from the output voltage of the GMR element 4 on which the variation is reflected.

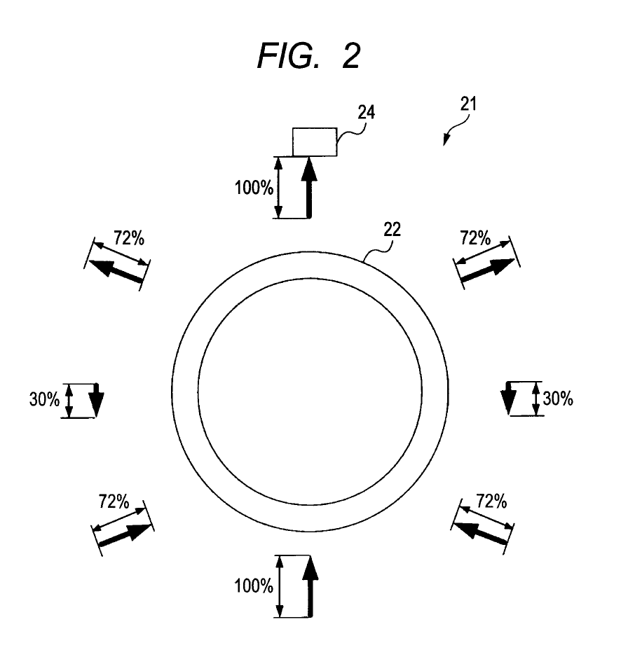

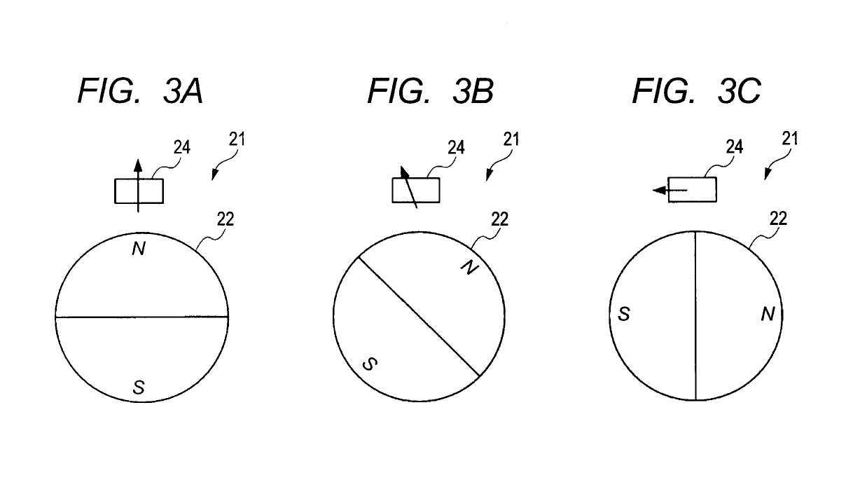

Next, a comparative example will be described to compare the angle sensor according to this embodiment. FIG. 2 is a diagram illustrating the magnetic field generated from an angle sensor according to the comparative example. FIGS. 3A to 3C are diagrams illustrating state transition of the angle sensor according to the comparative example. An angle sensor 21 shown in FIGS. 2 and 3A to 3C has the same configuration as that of the angle sensor 1 of this embodiment except that the circular yoke 3 is not provided. Therefore, the description of the same configuration will not be repeated. Arrows in FIG. 2 indicate magnetic vectors in the respective magnetic fields. Only eight magnetic vectors are illustrated in FIG. 2 for easy description.

In the angle sensor 21 according to the comparative example, as shown in FIG. 2, the strength of the magnetic field is the maximum near the N pole when the N pole of the magnet 22 is located at the initial position at which the N pole faces the GMR element 24. The strength of the magnetic field decreases to 72% of the maximum magnetic field at the position at which the magnet is rotated by about 45 degrees from the N pole. The strength of the magnetic field decreases to 30% of the maximum magnetic field at the position at which the magnet is rotated by 90 degrees from the N pole. Moreover, the strength of the magnetic field again increases 72% of the maximum magnetic field at the position at which the magnet is rotated by about 135 degrees from the N pole. The strength of the magnetic field becomes the maximum at the position at which the magnet is rotated by 180 degrees from the N pole. Thus, the strength of the magnetic field is the maximum near both poles and is the minimum at the intermediate positions between the both poles in the magnetic field.

As shown in FIG. 3A, the rotation angle of the magnet 22 matches the magnetic field angle of the magnetic vector when the magnet 22 is located at the initial position. It is assumed that the initial position is 0 degree. When the magnet 22 is rotated clockwise by 45 degrees, as shown in FIG. 3B, an angle deviation occurs between the rotation angle of the magnet 22 and the magnetic field angle of the magnetic vector. Specifically, the magnetic field angle of the magnetic vector becomes smaller than the rotation angle of the magnet 22. When the magnet 22 is further rotated clockwise by 45 degrees, as shown in FIG. 3C, the rotation angle of the magnet 22 once again matches the magnetic field angle of the magnetic vector.

Although not illustrated, the rotation angle of the magnet 22 matches the magnetic field angle of the magnetic vector when the magnet 22 is rotated clockwise by 180 degree and 270 degrees. Moreover, when the magnet 22 is rotated by 135 degrees, 225 degrees, and 315 degrees, the same angle deviation occurs, as shown in FIG. 3B. The reason that the angle deviation occurs at angles other than 0 degrees, 90 degrees, 180 degrees, and 270 degrees as the rotation angle of the magnet 22 is that the amplitude ratio of the orthogonal component (a component in an X direction and a component in a Y direction) of the magnetic field is not 1 when the rotation angle of the magnet 22 varies.

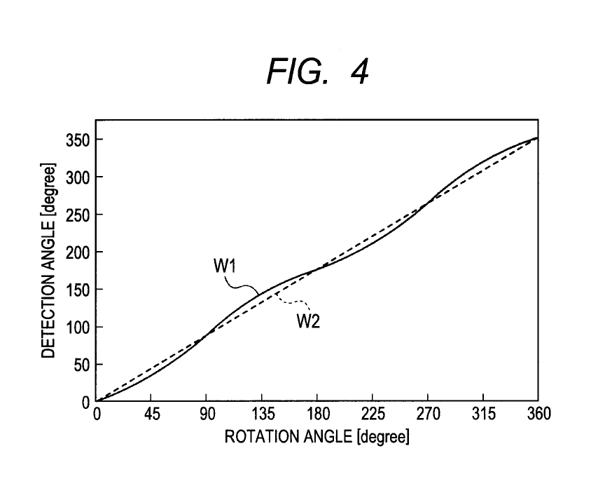

Here, the relationship between the rotation angle of the magnet 22 and the detection angle detected by the GMR element 4 is shown in FIG. 4. FIG. 4 is a diagram illustrating a linear characteristic of the angle sensor according to the comparative example. In FIG. 4, the vertical axis represents the detection angle and the horizontal axis represents the rotation angle of the magnet. A solid line W1 represents the linear characteristic and a dashed line W2 represents an ideal linear characteristic.

As shown in FIG. 4, it can be understood that the detection angle is considerably smaller than the rotation angle of the magnet 22 when the magnet 22 is rotated by 45 degrees and 225 degrees, whereas the detection angle is considerably larger than the rotation angle of the magnet 22 when the magnet 22 is rotated by 135 degrees and 315 degrees. Accordingly, it is difficult for the angle sensor 21 according to the comparative example to appropriately detect the rotation angle of the magnet 22.

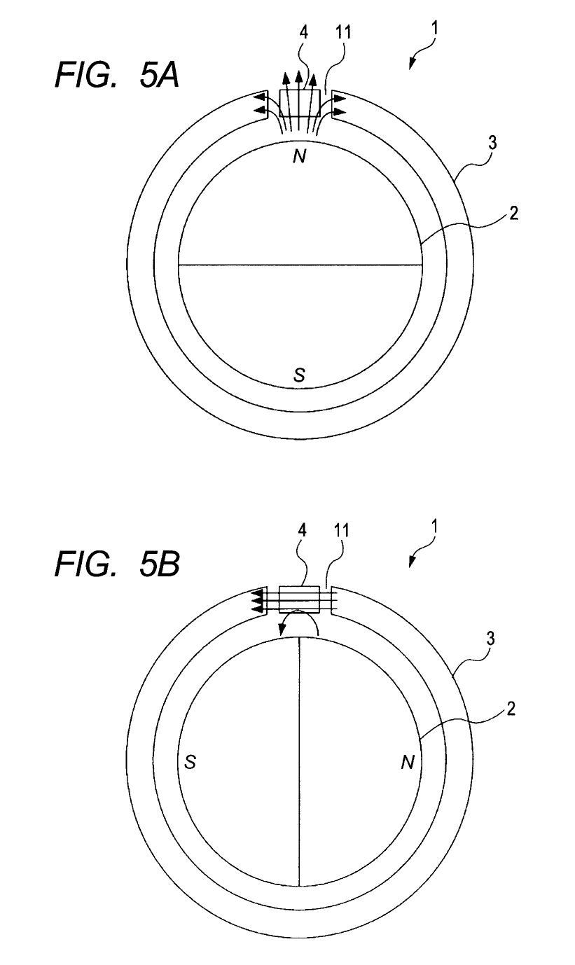

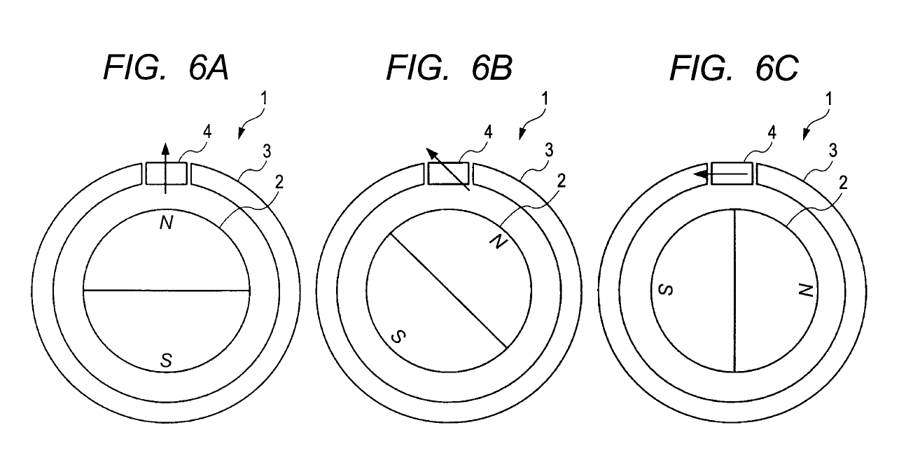

Next, the angle detection precision of the angle sensor according to this embodiment will be described. FIG. 5A is a diagram illustrating the state of a magnetic flux applied to the GMR element when the magnet is located at the initial position. FIG. 5B is a diagram illustrating the state of a magnetic flux applied to the GMR element when the magnet is located at the position at which the magnet is rotated by 90 degrees from the initial position. FIGS. 6A to 6C are diagrams illustrating the state transition of the angle sensor according to this embodiment. In FIGS. 5A and 5B, only the magnetic flux near the notched portion 11 is illustrated.

As shown in FIG. 5A, the magnetic flux is drawn toward the circular yoke 3 via the notched portion 11 and thus the magnetic flux applied to the GMR element 4 decreases, when the N pole of the magnet 2 is located at the initial position at which the N pole faces the GMR element 4. On the other hand, as shown in FIG. 5B, the magnetic flux is drawn by the circular yoke 3 and thus the magnetic flux applied to the GMR element 4 increases when the magnet 2 is rotated by 90 degrees from the initial position. Thus, the circular yoke 3 draws the magnetic flux toward the circular yoke 3 at a position at which the strength of the magnetic field is strong and forms a magnetic path to prevent the magnetic flux from leaking at a position at which the strength of the magnetic field is weak.

In this case, as shown in FIG. 6A, when the initial position of the magnet 2 is assumed to be 0 degrees, the rotation angle of the magnet 2 matches the magnetic field angle of the magnetic vector at 0 degrees. When the magnet 2 is rotated clockwise by 45 degrees from the above state, as shown in FIG. 6B, the magnetic field angle of the magnetic vector becomes about 45 degrees. When the magnet is rotated clockwise by 90 degrees from the initial position, as shown in FIG. 6C, the magnetic field angle of the magnetic vector also becomes 90 degrees. Moreover, when the magnet 2 is rotated by 135 degrees, 180 degrees, 225 degrees, 270 degrees, 315 degrees, or 360 degrees, the rotation angle of the magnet 2 matches the magnetic field angle of the magnetic vector.

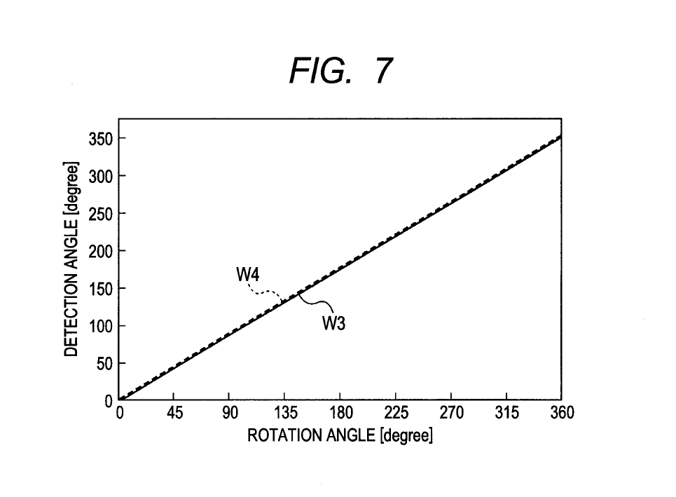

Here, the relationship between the rotation angle of the magnet 2 and the detection angle detected by the GMR element 4 is shown in FIG. 7. FIG. 7 is a diagram illustrating a linear characteristic of the angle sensor according to this embodiment. In FIG. 7, the vertical axis represents the detection angle and the horizontal axis represents the rotation angle of the magnet. A solid line W3 represents the linear characteristic and a dashed line W4 represents an ideal linear characteristic.

As shown in FIG. 7, the angle sensor 1 according to this embodiment has a slope which is substantially the same as the slope of the ideal linear characteristic and can detect the rotation angle of the magnet 2 without the angle deviation. Thus, since the circular yoke 3 uniformly forms the strength of the magnetic field (the size of the magnetic vector) applied to the GMR element 4 irrespective of the rotation position of the magnet 2, the amplitude ratio of the orthogonal component of the magnetic field applied to the GMR element 4 is 1 and thus the rotation angle of the magnet 2 can be made to match the magnetic field angle.

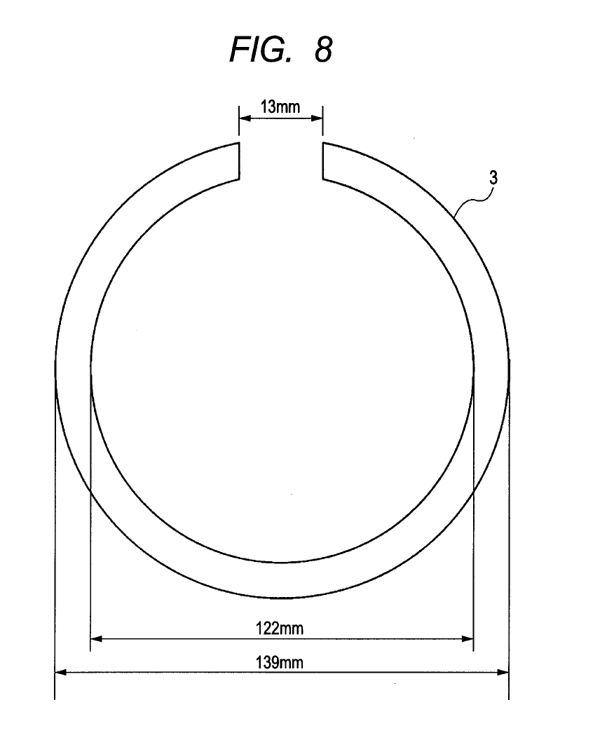

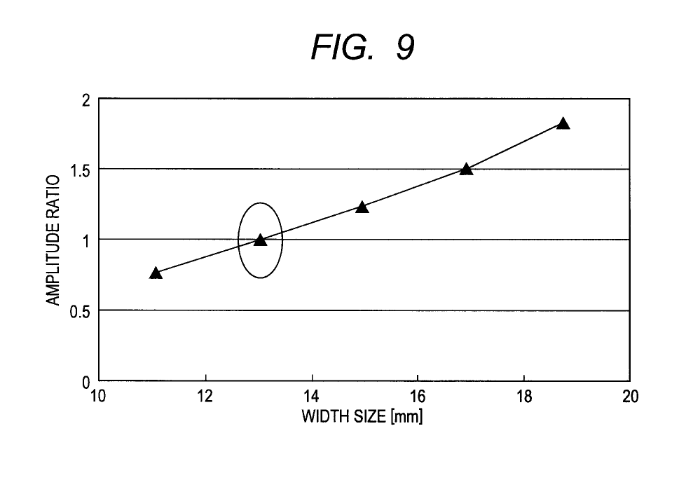

Next, a method of determining the width size of a gap width of the notched portion in the X direction will be described with reference to FIGS. 8 and 9. FIG. 8 is a diagram illustrating a design of the circular yoke. FIG. 9 is a diagram illustrating the relationship between the width size of the gap width of the circular yoke shown in FIG. 8 and the amplitude ratio of the orthogonal component of the magnetic field applied to the GMR element 4. In FIG. 9, the vertical axis represents the amplitude ratio and the horizontal axis represents the width size of the gap width of the notched portion 11.

As shown in FIG. 8, the inner diameter and the outer diameter of the circular yoke 3 are 122 [mm] and 139 [mm], respectively. In the angle sensor 1 using the circular yoke 3, as shown in FIG. 9, the width size is about 13 [mm] when the amplitude ratio obtained by dividing the component of the magnetic field applied to the GMR element 4 in the Y direction by the component of the magnetic field in the X direction is 1. Accordingly, since the amplitude ratio of the orthogonal component of the magnetic field applied to the GMR element 4 becomes 1 by setting the width size of the notched portion 11 to 13 [mm], the rotation angle of the magnet 2 can be made to match the magnetic field angle.

On the assumption that the width size of the gap width of the notched portion 11 is L1 and the center diameter of the circular yoke 3 is L2, the width size of the gap width of the notched portion 11 satisfies Expression (1) below.

L1=L2/10 (1)

From Expression (1), it can be understood that the width size of the gap width of the notched portion 11 is automatically determined when the center diameter of the circular yoke 3 is determined.

In this embodiment, the outer diameter and the inner diameter of the circular yoke 3 are 139 [mm] and 122 [mm], respectively. Therefore, the center diameter of the circular yoke 3 is half of the sum of the outer diameter and the inner diameter, that is, 130.5 [mm] The width size of the gap width of the notched portion 11 is 1/10 of the center diameter, that is, 13.05 [mm] Therefore, the width size is nearly the same as the 13 [mm].

As described above, in the angle sensor 1 according to this embodiment, the magnetic path is formed by the circular yoke 3 in which the notched portion 11 is formed. Therefore, since the strength of the magnetic field applied to the GMR element 4 is uniform irrespective of the rotation position of the magnet 2, the rotation angle of the magnet can be made to match the direction of the magnetic field applied to the magneto-resistive effect element, thereby improving the angle detection precision.

In the above-described embodiment, the width size of the gap width of the notched portion 11 is set to be 1/10 of the center diameter of the circular yoke 3. However, when the center diameter of the circular yoke 3 is in the range from ⅛ to 1/12, the angle sensor 1 realizing satisfactory angle detection precision can be configured.

Next, another embodiment of the invention will be described. The angle sensor according to another embodiment of the invention is different from the angle sensor according to the above-described embodiment in that another notched portion in which the GMR element is disposed is provided and a notched portion for magnetic resistance adjustment of the magnetic path is provided. Thus, only the difference will be described in detail.

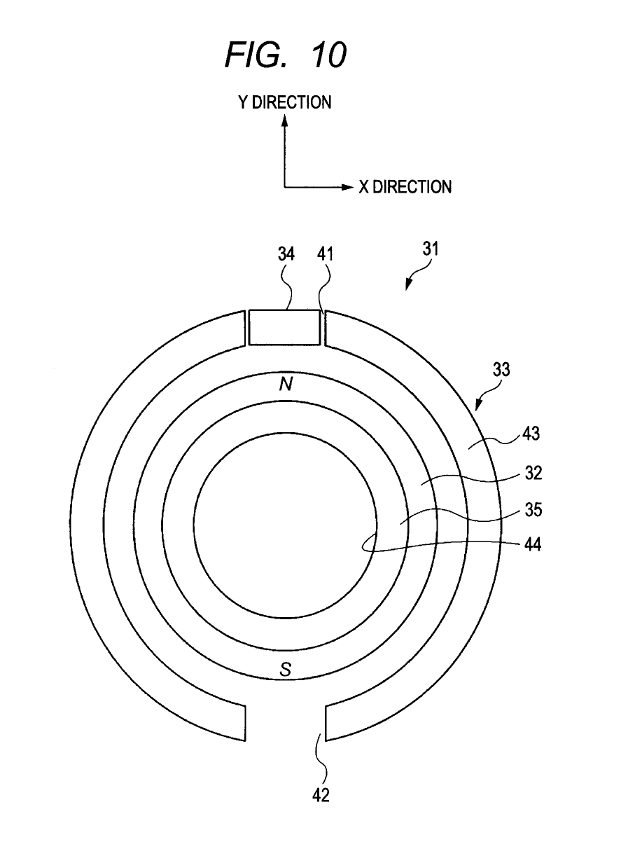

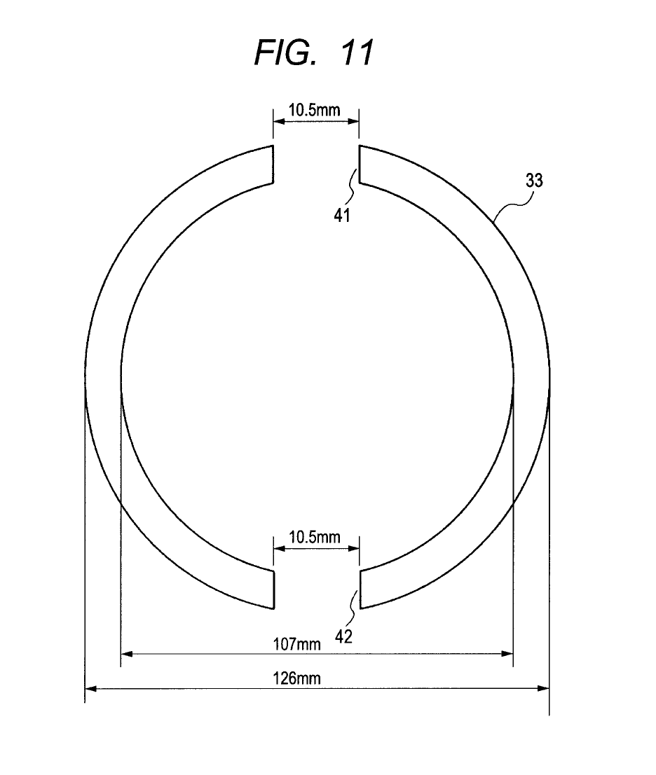

The angle sensor according to another embodiment of the invention will be described with reference to FIGS. 10 and 11. FIG. 10 is a schematic view illustrating the angle sensor according to another embodiment of the invention. FIG. 11 is a diagram illustrating the design of a circular yoke according to another embodiment of the invention.

As shown in FIG. 10, an angle sensor 31 according to this embodiment includes a magnet 32 with an annular shape, a circular yoke 33 surrounding the outer circumferential surface of the magnet 32 and having a first notched portion 41 and a second notched portion 42 facing each other with the center of the magnet 32 therebetween, and a GMR element 34 disposed in the first noticed portion 41 of the circular yoke 33. An annular mounting member 35 is disposed on the inner circumferential surface of the magnet 32 and a mounting hole 44 through which a crank shaft (not shown) or the like can be inserted is formed in the middle of the mounting member 35.

In the circular yoke 33, the first notched portion 41 and the second notched portion 42 are formed at the positions of the annular unit 43 facing each other. The annular unit 43, the first notched portion 41, the second notched portion 42 of the circular yoke 33 form a magnetic path of the magnetic field generated from the magnet 32. The strength of the magnetic field applied to the GMR element 34 is uniformly maintained by the first notched portion 41, irrespective of the rotation angle of the magnet 32. The magnetic resistance of the magnetic path in the circular yoke 33 is adjusted by the second notched portion 42. Since the gap widths of the first notched portion 41 and the second notched portion 42 are the same as each other, the magnetic resistance of the magnetic path along which the magnetic flux passes though the first notched portion 41 in the circular yoke 33 and the magnetic resistance of the magnetic path along which the magnetic flux passes though the second notched portion 42 are adjusted so as to be the same as each other.

In this case, the width sizes of the gap widths of the first notched portion 41 and the second notched portion 42 are slightly smaller than the length which is 1/10 of the center diameter of the above-described circular yoke 33. In this embodiment, as shown in FIG. 11, the outer diameter and the inner diameter of the circular yoke 33 are 126 [mm] and 107 [mm], respectively, and the width sizes of the gap widths of the first notched portion 41 and the second notched portion 42 are 10.5 [mm] The width sizes of the gap widths of the first notched portion 41 and the second notched portion 42 are about 1/11 of the center diameter of the circular yoke 33.

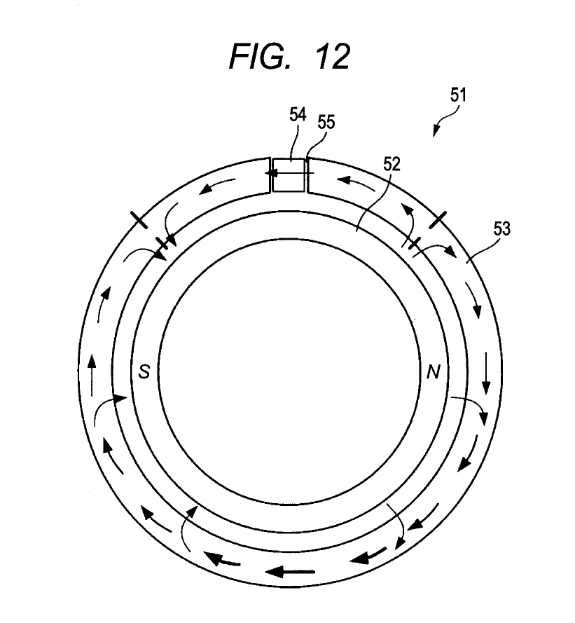

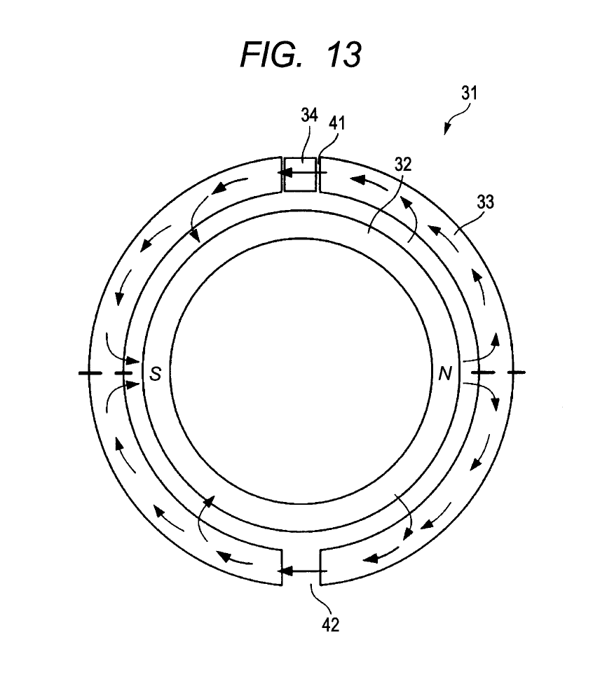

Next, the flow of a magnetic flux in the circular yoke will be described with reference to FIGS. 12 and 13. FIG. 12 is a diagram illustrating the flow of the magnetic flux of the angle sensor according to a comparative example to compare this angle sensor to the angle sensor according to another embodiment of the invention. FIG. 13 is a diagram illustrating the flow of the magnetic flux of the angle sensor according to another embodiment of the invention.

First, the flow of the magnetic flux of the angle sensor according to the comparative example will be described. In an angle sensor 51 according to the comparative example, as shown in FIG. 12, a notched portion 55 is formed only in a part of a circular yoke 53 and a GMR element 54 is disposed in the notched portion 55. In this case, since the notched portion 55 is only formed in a part of the circular yoke 53, a large bias occurs in the magnetic resistance along the magnetic path along which the magnetic flux reflows via the notched portion 55 (the GRAM element 54) and the magnetic path along which the magnetic flux reflows around the notched portion 55, in a case where there is no magnetic pole of the magnet 52 at the facing position of the notched portion 55.

Therefore, since the magnetic resistance of the magnetic path along which the magnetic flux reflows around the notched portion 55 becomes smaller than the magnetic resistance of the magnetic path along which the magnetic flux reflows via the notched portion 55, the boundaries, which are indicated by the dashed lines, of the magnetic paths in the circular yoke 53 are located together near the notched portion 55 with respect to the magnetic axis binding both magnetic poles of the magnet 52. Therefore, the magnetic flux is drawn in a direction in which the magnetic resistance is low in the circular yoke 53 and the magnetic flux flowing toward the notched portion 55 decreases and the magnetic flux applied to the GMR element 54 disposed in the notched portion 55 decreases, thereby decreasing detection sensitivity. On the other hand, the magnetic flux flowing toward the side facing the notched portion 55 increases, the magnetic flux is saturated on the side facing the notched portion 55 with the center of the magnet 52 therebetween in the circular yoke 53, and thus the magnetic flux may leak toward the outside of the circular yoke 53.

In the angle sensor according to the comparative example, the angle detection precision can be improved by disposing the GMR element 54 in the notched portion 55 of the circular yoke 53 so that the rotation angle of the magnet 52 matches the direction of the magnetic field applied to the GMR element 54. However, it is difficult to obtain sufficient detection sensitivity.

As shown in FIG. 13, however, in the angle sensor 31 according to this embodiment, the first notched portion 41 and the second notched portion 42 are formed so as to have the same gap width at the positions facing each other with the magnet 32 interposed therebetween. In this case, even when there is no magnetic pole of the magnet 32 at the facing positions of the first notched portion 41 and the second notched portion 42, the magnetic resistance of the magnetic path along which the magnetic flux reflows via the first notched portion 41 (the GMR element 34) becomes the same as the magnetic resistance of the magnetic path along which the magnetic flux reflows via the second notched portion 42.

Therefore, since the magnetic resistance of the magnetic path on the first notched portion 41 is the same as the magnetic resistance of the magnetic path on the second notched portion 42 in circular yoke 33, the boundary between the magnetic paths in the circular yoke 33 is located on the extension of the magnetic axis of the magnet 32. Therefore, the reduction in the magnetic flux flowing toward the first notched portion 41 is suppressed and the magnetic flux applied to the GMR element 34 disposed in the first notched portion 41 increases, thereby improving the detection sensitivity in the circular yoke 33. On the other hand, the magnetic flux flowing toward the second notched portion 42 decreases, and the magnetic flux on the side of the second notched portion 42 is prevented from being saturated, thereby preventing leakage of the magnetic flux.

In the angle sensor according to this embodiment, the first notched portion 41 and the second notched portion 42 are formed in the circular yoke 33 and the GMR element 34 is disposed in the first notched portion 41. Accordingly, the angle detection precision can be improved. Moreover, the detection sensitivity can be improved by eliminating the bias of the magnetic flux density on the first notched portion 41 and the second notched portion 42 of the circular yoke 33.

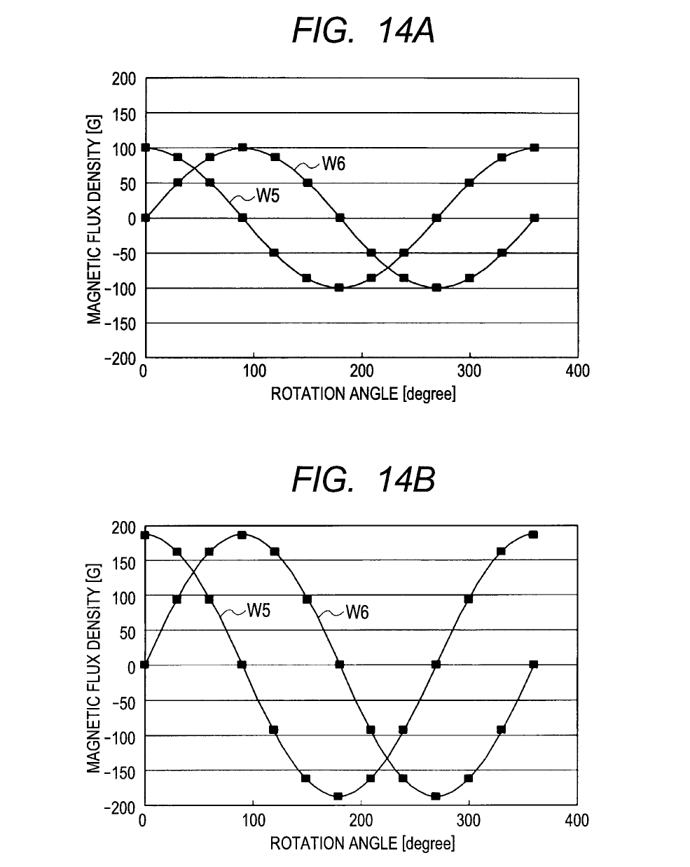

The variation widths of the magnetic flux densities of the rotation angle of the angle sensor according to the comparative example and the angle sensor according to this embodiment are shown in FIGS. 14A and 14B. FIG. 14A is a diagram illustrating the sensitivity characteristic of the angle sensor according to the comparative example. FIG. 14B is a diagram illustrating the sensitivity characteristic of the angle sensor according to this embodiment. In FIGS. 14A and 14B, the vertical axis represents the magnetic flux density and the horizontal axis represents the rotation angle of the magnet. A solid line W5 represents the Y direction component of the magnetic flux applied to the GMR element. A solid line W6 represents the X direction component of the magnetic flux applied to the GMR element.

As shown in FIGS. 14A and 14B, the variation width of the magnetic flux density of the angle sensor 51 according to the comparative example is about 200 [G] and the variation width of the magnetic flux density of the angle sensor 31 according to this embodiment is about 380 [G]. The variation width of the magnetic flux density of the angle sensor 31 according to this embodiment is about double the variation width of the magnetic flux density of the angle sensor 51 according to the comparative example. Therefore, the detection sensitivity is doubled.

In the angle sensor 31 according to this embodiment, the strength of the magnetic field applied to the GMR element 34 is uniform irrespective of the rotation position of the magnet 32, since the magnetic path is formed in the circular yoke 33 in which the first notched portion 41 and the second notched portion 42 are formed. Therefore, since the rotation angle of the magnet can be made to match the direction of the magnetic field applied to the magneto-resistive effect element, the angle detection precision can be improved. Moreover, since the magnetic resistance of the magnetic path on the side of the first notched portion 41 is the same as the magnetic resistance of the magnetic path on the side of the second notched portion 42 in the circular yoke 33, the bias of the magnetic flux density in the circular yoke 33 can be prevented. Accordingly, by preventing the magnetic flux applied to the magneto-resistance effect element from decreasing, the detection sensitivity can be improved and the leakage of the magnetic flux can be prevented.

According to another embodiment described above, the width size of the gap width of the notched portion 55 is set to be 1/11 of the center diameter of the circular yoke 33. However, the angle sensor 31 realizing the satisfactory angle detection precision can be configured, as long as the center diameter of the circular yoke 33 is in the range from ⅛ to 1/12.

According to another embodiment described above, the first notched portion 41 and the second notched portion 42 are formed in the circular yoke 33, but the invention is not limited to this configuration. For example, three or more notched portions may be formed in the circular yoke 33, as long as the magnetic resistance of the magnetic path along which the magnetic flux flows in one direction of the circular yoke 33 is nearly the same as the magnetic resistance of the magnetic path along which the magnetic flux flows in the reverse direction to the one direction.

According to another embodiment described above, the first notched portion 41 and the second notched portion 42 having the same gap width are formed at the positions of the circular yoke 33 facing each other, but the invention is not limited to this configuration. For example, the gap width of the second notched portion 42 may be larger than the gap width of the first notched portion 41, as long as the magnetic resistance of the magnetic path on the side of the first notched portion 41 is nearly the same as the magnetic resistance of the magnetic path on the side of the second notched portion 42.

The magnetic resistance of the magnetic path along which the magnetic flux flows in one direction may not be completely the same as the magnetic resistance of the magnetic path along which the magnetic flux flow in the reverse direction to the one direction. The magnetic resistances of the magnetic paths may be close to each other, as long as the magnetic flux applied to the GMR element 34 is prevented from decreasing and the leakage of the magnetic flux from the circular yoke 33 can be prevented.

According to the embodiments described above, the GMR elements 4 and 34 have been described as the magneto-resistive effect elements, but the invention is not limited to this configuration. For example, an MR element or the like may be used.

According to the embodiments described above, the magnets 2 and 32 and the circular yokes 3 and 33 are formed in the annular shape, but the invention is not limited to this configuration. Instead, the magnets and the circular yokes may be formed in a polygonal circular shape, as long as the strength of the magnetic field applied to the GMR elements 4 and 34 are uniform irrespective of the rotation angle of the magnets 2 and 32. A part of the circular yoke 3 or 33 may be cut, as long as the magnetic path is not shielded and the strength of the magnetic field applied to the GMR element 4 or 34 is uniform irrespective of the rotation angle of the magnet 2 or 32.

The disclosed embodiments are just exemplary embodiments, but the invention is not limited to the embodiments. The scope of the invention can be understood from not only the above-described embodiments but also the claims, and is intended to include all modifications of the equivalent meaning and scope of the claims.

As described above, according to the embodiments of the invention, it is possible to obtain the advantages of improving the angle detection precision using the magneto-resistance effect element. In particular, it is useful in the angle sensor requiring high angle detection precision.

It should be understood by those skilled in the art that various modifications, combinations, sub-combinations and alterations may occur depending on design requirements and other factors insofar as they are within the scope of the appended claims of the equivalents thereof.

What is claimed is:

1. An angle sensor comprising:
a magnet mounted in a rotatable rotation body so as to be rotatable with the rotation body;
a circular yoke extending in a circular shape so as to surround an outer circumferential surface of the magnet around a rotation shaft of the magnet and having a notched portion in a part thereof in an extension direction of the circular yoke; and
a magneto-resistive effect element disposed in the notched portion,
wherein the magneto-resistive effect element detects a direction of a magnetic field matching a rotation angle of the magnet in the notched portion.

2. The angle sensor according to claim 1, wherein the outer circumferential surface of the magnet around the rotation shaft of the magnet is circular.

3. The angle sensor according to claim 1, wherein the notched portion has a gap width so that an amplitude ratio of an orthogonal component of a magnetic field applied to the magneto-resistive effect element is 1.

4. The angle sensor according to claim 1,
wherein the circular yoke is formed in a circular ring shape, and
wherein the gap width of the notched portion is in the range from ⅛ to 1/12 of a center diameter of the circular yoke.

5. The angle sensor according to claim 4, wherein the gap width of the notched portion is 1/10 of the center diameter of the circular yoke.

6. An angle sensor comprising:
a magnet mounted in a rotatable rotation body so as to be rotatable with the rotation body;
a circular yoke extending in a circular shape so as to surround an outer circumferential surface of the magnet around a rotation shaft of the magnet and having a plurality of notched portions in parts thereof in an extension direction of the circular yoke; and
a magneto-resistive effect element disposed in one of the plurality of notched portions and detecting a direction of a magnetic field generated in the notched portion in which the magneto-resistive effect element is disposed.

7. The angle sensor according to claim 6, wherein the outer circumferential surface of the magnet around the rotation shaft of the magnet is circular.

8. The angle sensor according to claim 6, wherein the plurality of notched portions is formed in the circular yoke so that a magnetic resistance of a magnetic path along which a magnetic flux flows through the circular yoke in one direction is substantially the same as a magnetic resistance of a magnetic path along which a magnetic flux flows through the circular yoke in a reverse direction to the one direction.

9. The angle sensor according to claim 6,
wherein the plurality of notched portions is two, and
wherein the two notched portions are formed at positions of the circular yoke which substantially face each other with a rotation center of the magnet therebetween.

10. The angle sensor according to claim 9, wherein gap widths of the two notched portions are formed so that an amplitude ratio of an orthogonal component of a magnetic field applied to the magneto-resistive effect element is 1.

11. The angle sensor according to claim 9,
wherein the circular yoke is formed in a circular ring shape, and
wherein the gap widths of the two notched portions are in the range from ⅛ to 1/12 of a center diameter of the circular yoke.
